(19) United States
(12) Patent Application Publication
(10) Pub. No.: US 2008/0174138 A1
(43) Pub. Date: Jul. 24, 2008

(54) Pickup tailgate loading ramp

(76) Inventor: George M. Huggins, Blanchard, OK (US)

Correspondence Address: James T. Robinson, 222 East Main Street, Norman, OK, 73069-1303, US

(21) Appl. No.: 12/077,760

(22) Filed: Mar. 21, 2008

Related U.S. Application Data
(63) Continuation-in-part of application No. 10/781,483, filed on Feb. 17, 2004, now abandoned.
Application No. 10/781,483 is a continuation-in-part of application No. 09/750,498, filed on Dec. 29, 2000, now abandoned.

(51) Int. Cl. B62D 33/00

(52) U.S. Cl. 296/61

(57) ABSTRACT

A tailgate and loading ramp for pickup trucks includes a rectangular tailgate section rigidly attached to an upper ramp section. The lower end of the upper ramp section is pivotally attached to a linkage member. A support member and a lower ramp section are also attached to the linkage member to form a strong but lightweight ramp from the road surface to the bed of the pickup truck.

### BACKGROUND OF THE INVENTION

1. Field of the Invention

This invention relates to a pickup tailgate loading ramp, and more particularly, but not by way of limitation, to a loading ramp for use in conjunction with a pickup truck, wherein the tailgate ramp of the present invention replaces the normal pickup truck tailgate. The tailgate ramp includes hinge assemblies and latching assemblies which cooperate with existing tailgate hardware to secure the tailgate ramp to the pickup truck. The terms pickup tailgate loading ramp and tailgate ramp, as used herein, refer to applicant's invention.

2. Discussion

Pickup trucks are well known, and their popularity continues to grow. They are used to carry a variety of cargo, including outdoor power equipment such as lawnmowers, garden tractors, all terrain vehicles, and golf carts. It is difficult, if not impossible, to load a riding lawnmower or an all terrain vehicle into the bed of a pickup truck when the truck is equipped with original equipment tailgate (sometimes also referred to as an endgate).

While ramps that also serve as tailgates are known for use on pickup trucks, the currently existing products have various disadvantages. Different pickup truck manufacturers use different latch mechanisms and different hinge assemblies for tailgates of different widths. Tailgate ramps were largely custom built for each model of each pickup truck in order to properly locate the locking mechanism at a proper height.

Moreover, most convertible endgates were relatively heavy, difficult to attach or remove, and difficult to deploy in a load position. Many of the latch mechanisms for tailgate ramps were difficult to operate.

Although pickup tailgate ramps are known in the art, until now no tailgate ramp has been suited both for supporting substantial loads such as all terrain vehicles, garden tractors, golf carts, and other recreational devices and also for easy installation and removal.

### SUMMARY OF THE INVENTION

Applicant's invention provides a combination tailgate and loading ramp for pickup trucks. A rectangular tailgate section is rigidly attached to an upper ramp section, whose lower end is pivotally attached to a linkage member. A support member and a lower ramp section are also attached to the linkage member to form a strong but lightweight ramp from the road surface to the bed of the pickup truck.

### BRIEF DESCRIPTION OF THE DRAWINGS

FIG. 1 shows the pickup tailgate loading ramp according to the present wherein the tailgate ramp is deployed in a vertical (i.e., stored) position.

FIG. 2 shows the pickup tailgate loading ramp shown in FIG. 1 wherein the tailgate ramp is deployed in a load position.

FIG. 3 is an enlarged detailed view of the pickup tailgate loading ramp shown in FIGS. 1 and 2.

FIG. 4 is a view of the tailgate ramp of FIGS. 1-3 wherein the left folding ramp assembly and the right folding ramp assembly are exploded upwardly away from the tailgate assembly.

FIG. 5 is a top plan view of the tailgate ramp of FIGS. 1-3.

FIG. 6 is a rear plan view of the tailgate ramp of FIGS. 1-3 from behind the pickup truck.

FIG. 7 is a bottom plan view of the tailgate ramp of FIGS. 1-3.

FIG. 8 is a left plan view of the left folding ramp assembly.

FIG. 9 is a right plan view of the right folding ramp assembly.

FIG. 10 is a front plan view of the tailgate ramp of FIGS. 1-3.

FIG. 11 is an exploded view of the left folding ramp assembly and the right folding ramp assembly.

FIG. 12 is a closeup view of the right latch assembly of the tailgate ramp shown in FIGS. 1-3.

FIG. 13 is an exploded view of the right latch assembly shown in FIG. 12.

FIG. 14 is an exploded view of the tailgate assembly, the left latch assembly, the right latch assembly, the left hinge assembly, and the right hinge assembly, all as shown in FIGS. 1-3, together with alternate latch assemblies and alternate hinge assemblies according to the present invention.

FIG. 15 shows still another latch assembly according to the present invention.

FIG. 16 is an enlarged view of the latch assembly of FIG. 15 with a portion of the tailgate assembly cut away.

FIG. 17 illustrates the movement of the tailgate ramp of FIGS. 1-3 from the vertical (i.e., stored) position shown in FIG. 1 to the load position shown in FIG. 2.

### DETAILED DESCRIPTION OF THE INVENTION

In the following description of the invention, like numerals and characters designate like elements throughout the figures of the drawings.

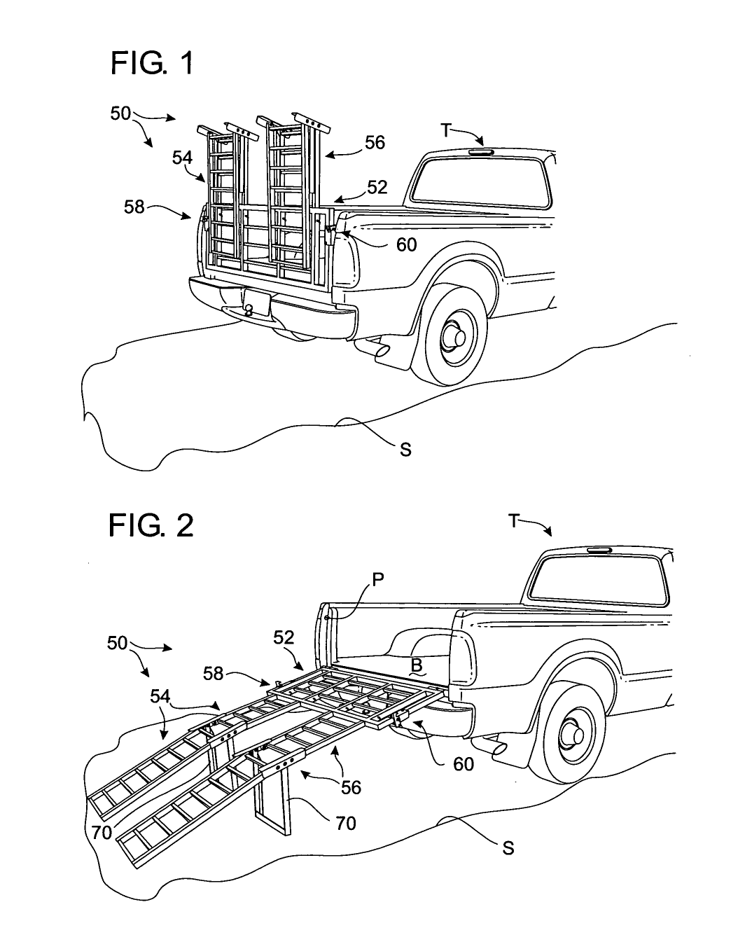

Referring now to the drawings generally and to FIG. 1 in particular, a pickup tailgate loading ramp 50 in accordance with the present invention is mounted on the pickup truck T resting on a road surface S using existing tailgate hardware (not shown). The tailgate ramp 50 includes a tailgate assembly 52, a left folding ramp assembly 54, a right folding ramp assembly 56, a left latch assembly 58, a right latch assembly 60, a left hinge assembly 62, and a right hinge assembly 64. The tailgate ramp 50 of FIG. 1 is shown in the vertical (i.e., storage) position.

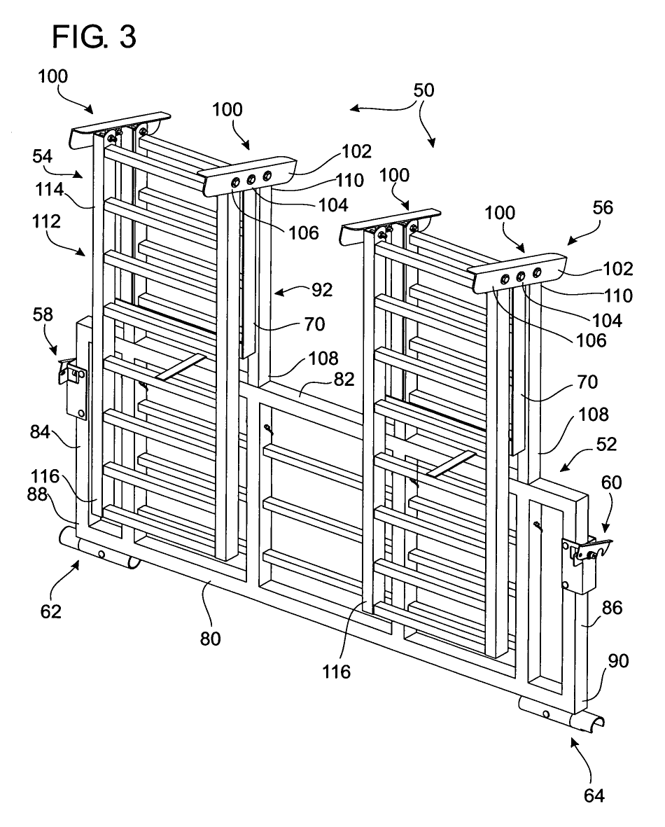

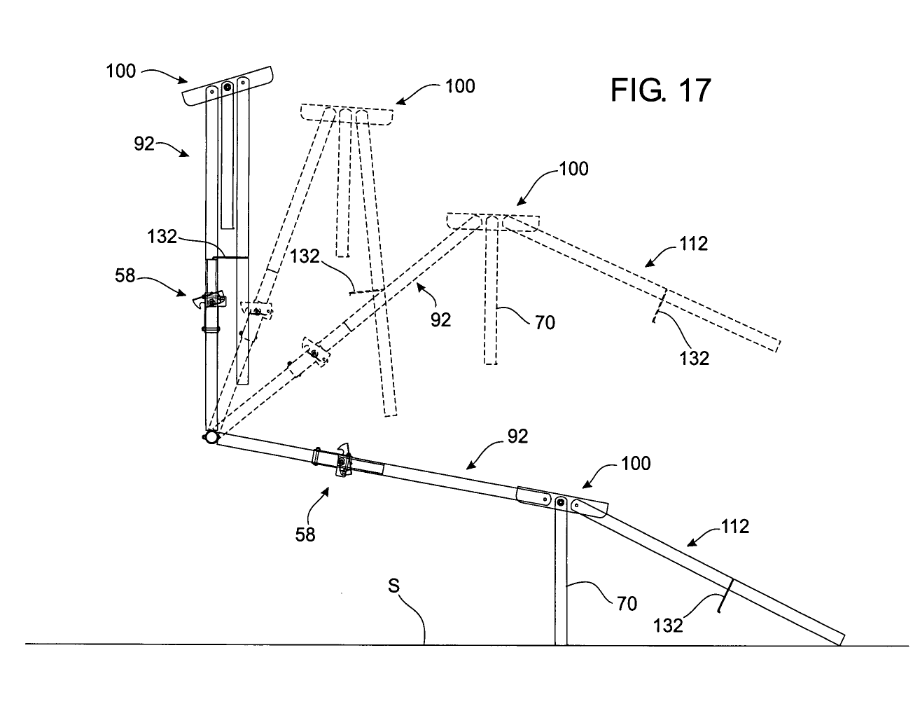

Referring now to FIG. 2, the tailgate loading ramp 50 is deployed in a load position so that the left folding ramp assembly 54 and the right folding ramp assembly 56 cooperate with the tailgate assembly 52 to create a continuous path from the surface S to the bed B of the pickup truck T. U-shaped support members 70 are attached to the left folding ramp assembly 54 and the right folding ramp assembly 56 (see FIG. 3 and FIG. 17).

Referring now to FIG. 3, the tailgate loading ramp 50 is shown detached from the pickup truck T. The tailgate assembly 52 includes a horizontal rail 80 and a parallel horizontal rail 82 interconnected by left end rail 84 and right end rail 86, having lower end portions 88, 90, respectively. The left latch assembly 58 is attached to the left end rail 84 and the right latch assembly 60 is attached to the right end rail 86. The left latch assembly 58 and the right latch assembly 60 engage existing tailgate latching pins P (see FIG. 2, only one shown) to secure the tailgate loading ramp 50 in the vertical position.

Still referring to FIG. 3, the left hinge assembly 62 is attached to the horizontal rail 80 adjacent the lower end portion 88 of the left end rail 84. The right hinge assembly 64 is attached to the horizontal rail 80 adjacent the lower end portion 90 of the right end rail 86. The left and right hinge assemblies, 62, 64, pivotally engage hinge pins P (now shown), standard tailgate attachment hardware located adjacent the bed B of the pickup truck T.

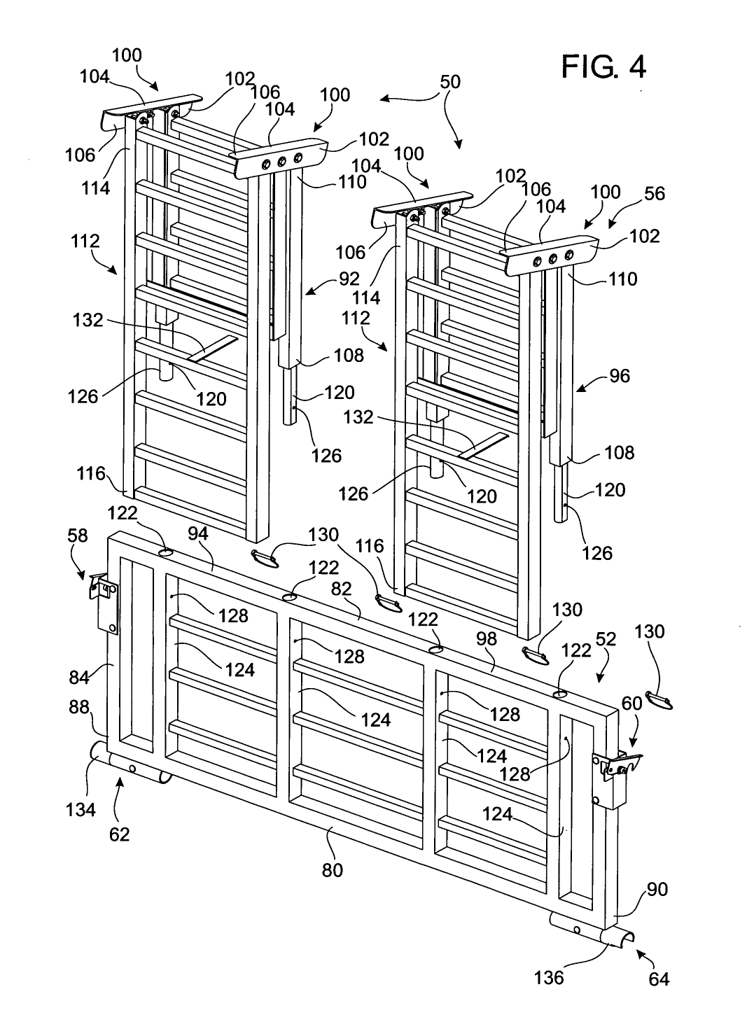

Still referring to FIG. 3, the left folding ramp assembly 54 includes an upper ramp section 92 attached at one end to a left end portion 94 of the parallel horizontal rail 82 (see FIGS. 4, 6,10, and 14). The right folding ramp assembly 56 includes an upper ramp section 96 attached at one end to a right end portion 98 of the parallel horizontal rail 82 (see FIGS. 4, 6,10, and 14). As used with respect to the folding ramp assemblies 54, 56, the term upper is used to indicate the structure so described is higher in elevation (and nearer the bed B of the pickup truck T) when the tailgate loading ramp 50 is deployed in the load position. Similarly, the term lower is used to indicate the structure so described is lower in elevation (and nearer the surface S on which the pickup truck T rests) when the tailgate loading ramp 50 is deployed in the load position.

Still referring to FIG. 3, the other end of each of the upper ramp sections 92, 96 is pivotally attached to a pair of linkages 100. Each linkage 100 has an upper portion 102, an intermediate portion 104, and a lower portion 106. Each of the upper ramp sections 92, 96 has an upper portion 108 and a lower portion 110. The ends of the upper ramp sections 92, 96 adjacent the upper portions 108 of the upper ramp sections 92, 96 are rigidly connected to the parallel horizontal rail 82. The other ends of the upper ramp sections 92, 96, adjacent the lower portions 110 of the upper ramp sections 92, 96, are pivotally attached to the linkages 100 adjacent the upper portion of linkage 102.

Still referring to FIG. 3, the ends of each of the U-shaped support members 70 are pivotally attached to the linkages 100 in the intermediate portion 104 of the linkages 100 by fasteners 118.

Still referring to FIG. 3, each folding ramp section 54, 56 includes a lower ramp section 112 having an upper end 114 and a lower end 116. The upper end 114 of each lower ramp section 112 is attached to two linkages 100 adjacent the lower portions of linkage 106 of the linkages 100. The lower end 116 of each lower ramp section 112 rests on the surface S when the tailgate ramp 50 is deployed in the load position.

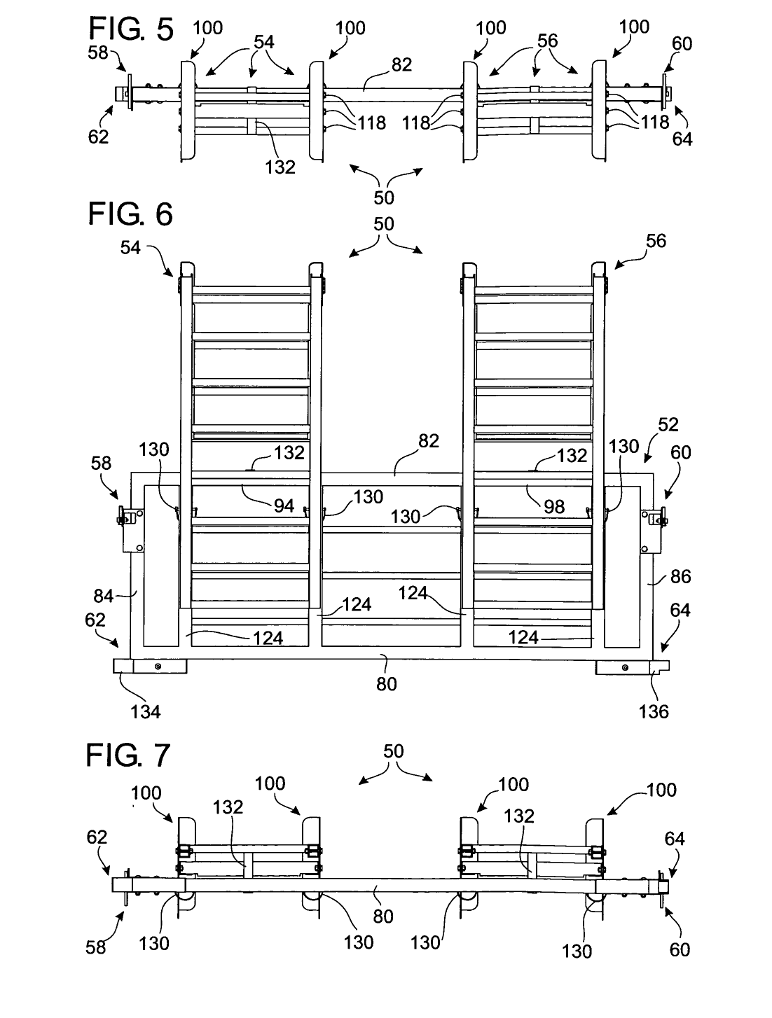

Referring now to FIGS. 4-10, the left upper ramp section 92 and the right upper ramp section 96 are exploded upwardly from the parallel horizontal rail 82. Projections 120 extending from the upper end portions 108 of the upper ramp sections 54, 56 are received through holes 122 in the parallel horizontal rail 82 and disposed within hollow frame members 124 of the tailgate assembly 52. When the projections 120 are disposed within the hollow frame members 124, horizontal bores 126 in the projections 120 mate with throughways 128 in the hollow frame members 124. Pins 130 secure the upper ramp sections 92, 96 to the tailgate assembly 52. Each fastener 130 extends through a throughway 128 and through the horizontal bore 126 in the projection 120.

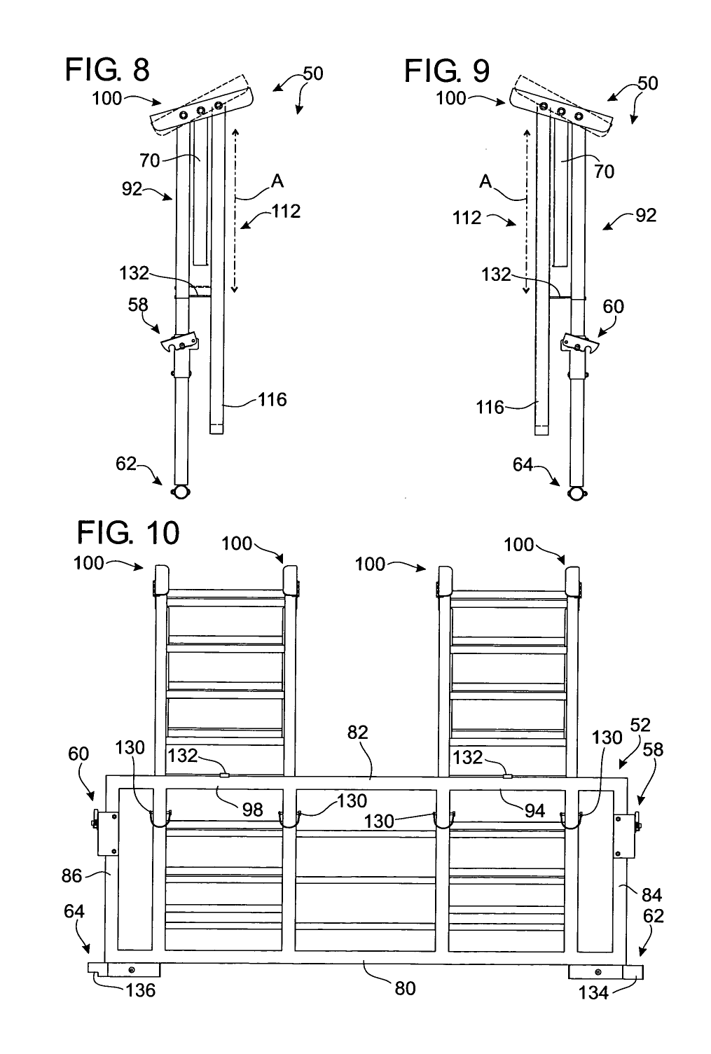

Still referring to FIGS. 4-10, holders 132 secure lower ramp sections 112 to the upper ramp sections 92, 96 when the tailgate ramp 50 is in the vertical (i.e., stored) position (see FIGS. 8 and 9).

Still referring to FIGS. 4-10, the left hinge assembly 62 includes a hollow cylindrical member 134 which receives a left hinge pin attached to the left side of the pickup truck T adjacent the bed B. The right hinge assembly 64 includes a partially cutaway cylindrical member 136 which mates with a mating right hinge pin attached to the right side of the pickup truck T adjacent the bed B.

The hinge pin assemblies 62, 64 according to the present invention match the factory equipment on the pickup truck T. It will be understood by one skilled in the art that a variety of mating configurations are known in the art. Applicant's invention is adaptable for use with any mating configuration which permits a tailgate to be easily removed and installed.

Referring now to FIGS. 8 and 9, an arrow A shows the direction of movement, in concert, of the left upper ramp portion 92 and the right upper ramp portion 96 as to raise the holder 132 which secures the

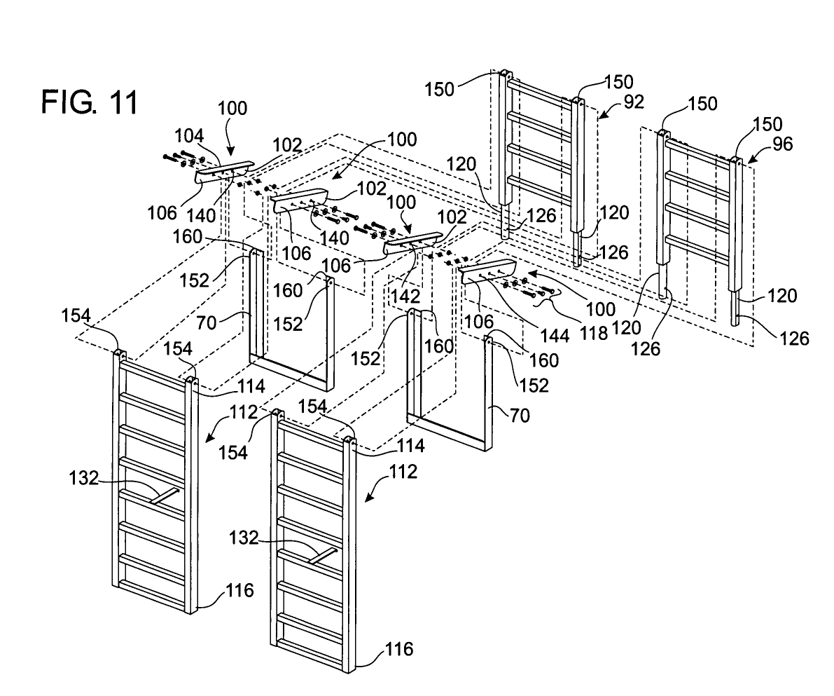

Referring now to FIG. 11, the folding ramp assemblies of the present invention are shown in exploded view. Each linkage 100 has a bore 140 located adjacent the upper portion 102 of the linkage 100, a bore 142 located in the intermediate portion 104 of the linkage 100, and a bore 144 located adjacent the lower portion 106 of the linkage 100. The upper ramp section 92 is attached to two linkages 100 by means of fasteners 118 disposed through the bores 140 of two linkages 100 and through bores 150 located adjacent the upper portion 108 of the upper ramp section 92. Likewise the upper ramp section 96 is attached to two linkages 100 by fasteners 118 disposed through the bores 140 of the two linkages 100 and through bores 150 located adjacent the upper portion 108 of the upper ramp section 96.

Each of the U-shaped support members 70 is attached to two linkages 100 by fasteners 118 disposed through the bores 142 located in the intermediate portions 104 of the two linkages 100 and through bores 152 adjacent the ends of the U-shaped support members 70.

Each of the lower ramp sections 112 is attached to two linkages 100 by fasteners 118 disposed through the bores 144 located adjacent the lower portion of the linkages 100 and through bores 154 adjacent the upper ends 114 of the lower ramp sections 112.

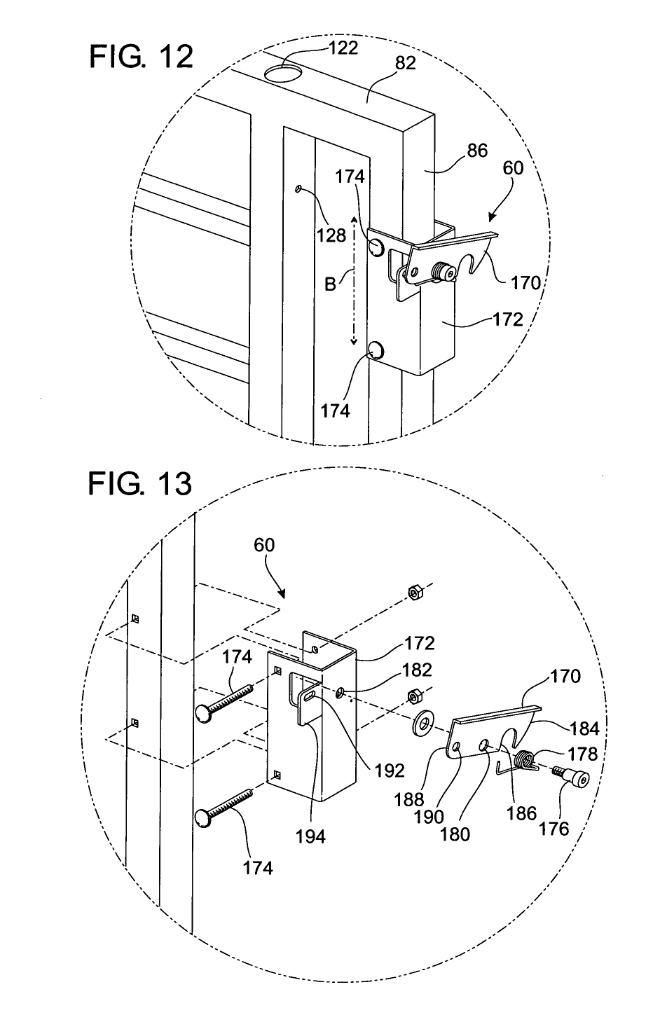

Referring now to FIGS. 12 and 13, the right latch assembly 60 according to the present invention is attached to the right end rail 86 of the tailgate assembly 52. A spring-biased latching arm 170 is attached to a latch support 172 attached to the right end rail 86 of the tailgate assembly 52 by latch support mounting security bolts 174. The spring-biased latching arm 170 rocks on a pivot bolt 176 which extends through a biasing spring 178 and through a bore 180 in the latching arm 170, and through a bore 182 in the latch support 172. One end 184 of the latching arm 170 includes a cutout 186 which engages the tailgate latching pin P provided as standard equipment on the pickup truck T (see FIG. 2). The other end 188 of the latching arm 170 includes a bore 190 which mates with a bore 192 in a tab portion 194 of the latch support 172 when the tailgate ramp 50 according to the present invention is in the vertical (i.e., storage) position. The latch support 172 is mounted at a convenient location along arrow B on the right end rail 86 of the tailgate assembly 52.

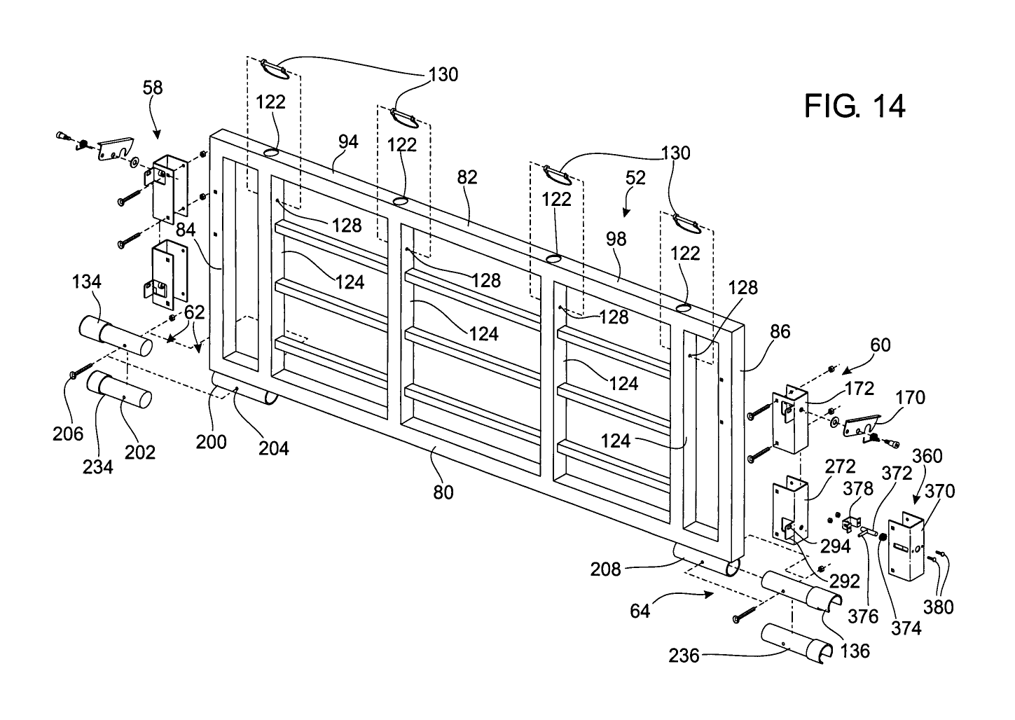

Referring now to FIG. 14, the left hinge assembly 62 consists of a hollow cylindrical member 134 disposed within a first tubular member 200 attached to the horizontal rail 80 of the tailgate assembly 52. The cylindrical member 134 has a transverse bore 202 which mates with a transverse bore 204 in the tubular member 200. A fastener 206 extends through the cylindrical member transverse bore 202 and the mating tubular member transverse bore 204 and thereby secures the hollow cylindrical member 134 within the tubular member 200.

Still referring to FIG. 14, the right latch assembly 64 consists of a partially cutaway hollow cylindrical member 136 secured in a second tubular member 208 attached to the horizontal rail 80 distal from the tubular member 200.

Still referring to FIG. 14, a hollow cylindrical member 234 having a length less than the length of the hollow cylindrical member 134 and a partially cutaway hollow cylindrical member 236 having a length less than the length of the partially cutaway hollow cylindrical member 136 permits the tailgate assembly 52 to be adapted for use in a pickup truck having a narrower tailgate width.

Ford, General Motors, and Daimler-Chrysler pickup trucks for model years 1999 through 2004 have similar tailgate latching mechanisms and similar hinge assemblies, but the position of the latching pin P and the width of the tailgate vary between the three manufacturers. It will be understood by one skilled in the art that the latch assembly 58, 60 and the hinge assembly 62, 64 of the present invention permit the adaptation of a single tailgate assembly 52 to any of the three manufacturers.

Still referring to FIG. 14, another latch support 272 includes a tab 292 having a bore 294 wherein the tab 292 is located near the bottom of the latch support 272. The latch support 272 facilitates the adaptation of the tailgate ramp 50 to a changed location of the latch pin P without drilling additional holes in the end rail 86 of the tailgate assembly 52.

Still referring to FIG. 14, another latch assembly 360 permits use of the tailgate assembly 52 of the present invention with Ford, General Motors, and Daimler-Chrysler pickup trucks for model years prior to 1999. A latch support 370 containing a spring-loaded latch pin 372 is mounted on the rail 86 of the tailgate assembly 52. A spring 374 biases the latch pin 372 in a distended position to engage a standard latch pin receiver in the pickup truck. A thumb lever 376 permits temporary disengagement of the latch pin 372 from the latch pin receiver for deployment of the tailgate ramp 50 in the load position. A backstop 378 is secured to the latch support 370 by fasteners 380 to limit travel of the latch pin 372 in the biased direction.

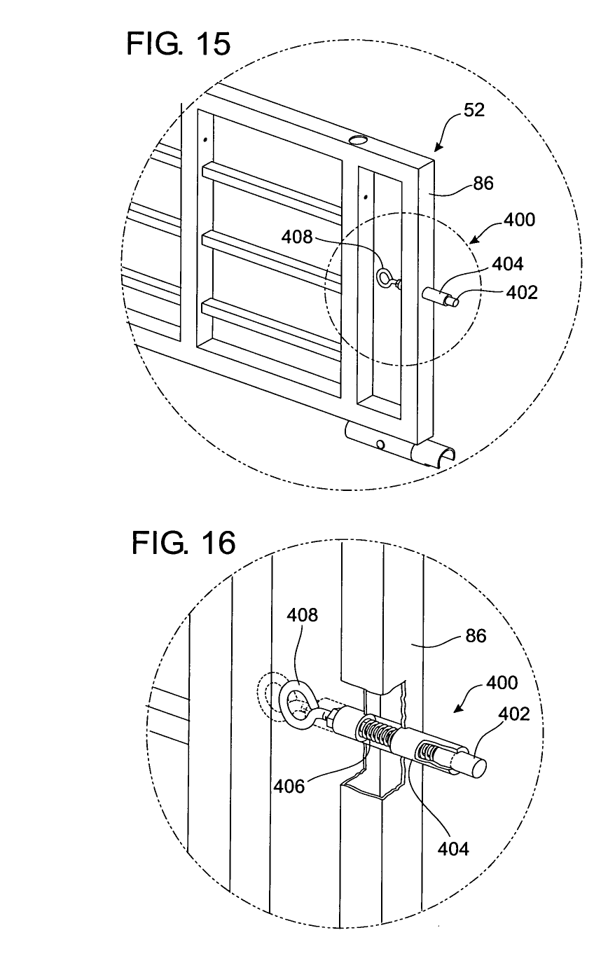

Referring now to FIGS. 15 and 16, shown therein is another latch assembly 400 for use according to the present tailgate ramp invention in Ford, General Motors, and Daimler-Chrysler pickup trucks for model years prior to 1999. A spring-loaded pull plunger 402 is housed in a cylindrical barrel 404. A spring 406 biases the plunger 402 in an extended position so the plunger 402 is disposed within the standard-equipment pickup truck latch pin receiver. A finger loop 408 permits manual withdrawal of the plunger 402 from the latch pin receiver.

Referring now to FIG. 17, a left plan view of the tailgate ramp according to the present invention shows the operation of applicant's invention. Movement of the lower ramp section 112 along arrow A permits disengagement of the holder 132 from the upper ramp section 92. As the lower ramp section 112 is pulled outwardly and downward, the U-shaped support member 50, the upper ramp section 92, and the lower ramp section 112 pivot at their points of attachment to the linkage 100 so that, when fully extended, the tailgate ramp 50 of the present invention provides a ramp from the road surface S to the bed B of the pickup truck T. The U-shaped support member 70 provides support for both the upper ramp section 92 and the lower ramp section 112 by virtue of their common connection to different points of attachment on the linkage 100.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. A pickup tailgate loading ramp for replacement of a standard pickup tailgate attached to the pickup by standard-equipment tailgate hardware, wherein said pickup tailgate loading ramp is adjustable between a vertical position when said pickup tailgate loading ramp is not being used for loading and a load position for moving materials and equipment from the road surface into the bed of the pickup truck, wherein the standard-equipment pickup tailgate hardware includes two latch pins and two hinge pins, said pickup tailgate loading ramp comprising:
a generally rectangular tailgate assembly having a first horizontal rail, an opposed second horizontal rail, and first and second end rails;
first and second hinge assemblies, wherein said first and second hinge assemblies are attached to said first horizontal rail and hingedly connect said first horizontal rail to said hinge pins;
first and second latch assemblies, wherein said first latch assembly is attached to said first end rail and said second latch assembly is attached to said second end rail, so that, when said pickup tailgate loading ramp is in the vertical position said first and second latch assemblies engage the standard-equipment latch pins and secure said pickup tailgate loading ramp to the pickup truck;
at least one folding ramp assembly, said folding ramp assembly further comprising:
an upper ramp section having an upper end and a lower end, said upper end of said upper ramp section being rigidly attached to said opposed horizontal rail of said tailgate section;
a lower ramp section having an upper end and a lower end;
a U-shaped support member; and
a linkage member, said linkage member being characterized as having an upper portion, an intermediate portion, and a lower portion, said upper ramp section being pivotally attached to said upper portion of said linkage member, said support member being attached to said intermediate portion of said linkage member, and said lower ramp section being pivotally attached to said lower portion of said linkage member;
so that, as said tailgate assembly is rotated on said first and second hinge assemblies, said upper ramp section and said lower ramp section are extended outwardly and down from the pickup truck until said lower end of said lower ramp section is in contact with the road surface and a ramp is formed for moving materials from the road surface to the bed of the pickup truck.
